(19) United States
(12) Patent Application Publication
(10) Pub. No.: US 2012/0221713 A1
(43) Pub. Date: Aug. 30, 2012

(54) MULTIFUNCTIONAL HOME NETWORK SYSTEM USING UBIQUITOUS COMPUTING

(76) Inventor: Woosoon Shin, Irvine, CA (US)

(21) Appl. No.: 13/127,030

(22) PCT Filed: Nov. 17, 2009
(86) PCT No.: PCT/KR2009/006755

§ 371 Date: Apr. 29, 2011

(51) Int. Cl. G06F 15/173

(52) U.S. Cl. 709/224

(57) ABSTRACT

The invention is related to a multifunctional home network system using ubiquitous computing. The system includes a home network equipment that communicate to a home gateway with wire/wireless inside a room, and can provide various services including security, home automation, multimedia, and medical service and transmit these information to a user located outside.

The multifunctional home network system using ubiquitous computing of this invention has technical characteristic in that it includes a home network equipment that comprises one of more among a security system that comprises an imaging device that is connected to a home gateway with wire/wireless communication method, cooling and heating system, and application equipments; a wire/wireless controller that can communicate wire/wireless with said home gateway to directly control said home network equipment via said home gateway, or to input control value for control under set value; an internet center that comprises a server to receive and store operation signal for said home network equipment via wire/wireless network, and transmits letters and images to user's external PC and portable wireless terminal that can control said home network equipment; and one or more receiving places among a security system, medical system and emergency rescue system that receive and monitor image and voice signals among said operation signals stored in said internet center.

### BACKGROUND OF THE INVENTION

The invention is related to a multifunctional home network system using ubiquitous computing. The system includes a home gateway and a home network equipment that communicate with wire/wireless inside a room; is provided with various services including security, home automation, multimedia, and medical service; transmits these information to user's external PC and portable wireless terminal that are located outside; and can control the home network equipment with the external PC and portable wireless terminal.

### TECHNOLOGICAL BACKGROUND INFORMATION

In general, home network refers to a future home environment in which PC and other information within home are integrated into a single network, and service is provided without constraints of equipment, time and place. In addition, demand for home networking is increasing according to development of networking technology, base software, and home information appliances, change of domestic communication and infrastructure, and increase of consumer's desire for intelligent home networking.

Home network is a communication network that is constructed to connect various digital home appliances, and provide high speed mutual communication function within home. Home network system using this is appearing naturally as movie compression technology, digital signal processing technology, operating system technology for informational home appliances develop; and necessity for high-quality image, video conference, digital movie and electronic control system within home is raised; and for this, home appliances are gradually digitalized, and loaded with network technology.

Media life service with home network uses general-purpose or allowed-purpose display devices such as television (hereinafter called ‘TV’) and remote controllers (hereinafter called ‘remocon’). Media life service is provided to group residential facilities such as intelligent apartments.

In a method providing such media life service with home network, method and system for providing media life service with home network by prior art enables successful realization of business in which a PLC gateway is combined to an IP set-top box in a home network, and simultaneously using ordinary televisions that correspond to general-purpose or allowed-purpose devices as the interface; use is easy with remote controller operation; and predetermined paid services together with various free services are provided in a group residential facility such as apartments.

But the above-mentioned method and system for providing media life service with home network are at a stage that only technical possibilities are reviewed, and many technical problems must still be solved in order to install home networks to all homes and generalize.

Above all, the above-mentioned method and system have problems that it is impossible to exchange information between home sensors and that they cannot provide various information and service based on ubiquitous computing technology in spite of that currently digital electronic devices are made intelligent and gradually developing into ubiquitous home, and various sensors are connected to the home network and made intelligent.

### DETAILED DESCRIPTION OF THE INVENTION

### Technical Task

The invention has a purpose of providing multifunctional home network system using ubiquitous computing, which includes an indoor home network equipment that can communicate wire/wireless with a home gateway, and can provide various services such as security, home automation, multimedia, and medical service.

### Technical Solution

A purpose of this invention is achieved by a multifunctional home network system using ubiquitous computing comprising a home network equipment that comprises one of more among a security system that comprises an imaging device that is connected to a home gateway with wire/wireless communication method, cooling and heating system, and application equipments; a wire/wireless controller that can communicate wire/wireless with said home gateway to directly control said home network equipment via said home gateway, or to input control value for control under set value; an internet center that comprises a server to receive and store operation signal for said home network equipment via wire/wireless network, and transmits letters and images to user's external PC and portable wireless terminal that can control said home network equipment; and one or more receiving places among a security system, medical system and emergency rescue system that receive and monitor image and voice signals among said operation signals stored in said internet center.

Another purpose of this invention is achieved by the multifunctional home network system using ubiquitous computing, further comprising a blind system that can communicate with said home gateway via RS-485.

Still another purpose of this invention is achieved by the multifunctional home network system using ubiquitous computing, wherein the blind system comprises an illumination sensor and an electronic curtain.

Still another purpose of this invention is achieved by the multifunctional home network system using ubiquitous computing, wherein said security system can communicate with said home gateway with an RCA cable.

Still another purpose of this invention is achieved by the multifunctional home network system using ubiquitous computing, wherein said security system comprises one or more among web-cam, CCTV, door bell, lock device, video phone and motion detection sensor.

Still another purpose of this invention is achieved by the multifunctional home network system using ubiquitous computing, wherein said web cam comprises a CMOS sensor, and LED lighting, a microphone, a speaker and a passive infrared ray detection sensor.

Still another purpose of this invention is achieved by the multifunctional home network system using ubiquitous computing, further comprising a multimedia platform that comprises an input port for input image signal and voice signal that are taken one or more among the webcam and the CCTV, a converter for converting the image signal that is input to said input port into analog image signal, a CPU for converting said image signal into a compressed image file format, an output port for outputting said compressed image file format, and a speaker for outputting said voice signal.

Still another purpose of this invention is achieved by the multifunctional home network system using ubiquitous computing, wherein said cooling and heating system can communicate with said home gateway using one or more among PLC and Zigbee.

Still another purpose of this invention is achieved by the multifunctional home network system using ubiquitous computing, wherein said cooling and heating system comprises a temperature sensor, a heater and a cooler.

Still another purpose of this invention is achieved by the multifunctional home network system using ubiquitous computing, wherein said application equipments comprise a kitchen device, a living room device and a wired medical measurement device.

Still another purpose of this invention is achieved by the multifunctional home network system using ubiquitous computing, further comprising one or more among an environment sensor and a wireless medical measurement device that can communicate with said home network by Zigbee.

Still another purpose of this invention is achieved by the multifunctional home network system using ubiquitous computing, wherein said environment sensor can sense heat, temperature, humidity, illumination, air clarity, and gas.

Still another purpose of this invention is achieved by the multifunctional home network system using ubiquitous computing, wherein said wire/wireless controller comprises a remote controller that can communicate with said home gateway by Zigbee, and a home PC that is connected with said home gateway by wire.

### ADVANTAGEOUS EFFECTS

The invention has an effect that includes a home network equipment that communicate with wire/wireless with a home gateway inside a room; is provided with various services including security, home automation, multimedia, and medical service; transmits these information to user's external PC and portable wireless terminal that are located outside; and can control the home network equipment with the external PC and portable wireless terminal.

### BRIEF DESCRIPTION OF DRAWINGS

FIG. 1 and FIG. 2 are diagrams for a home network system of this invention using ubiquitous computing,

FIG. 3 is a diagram for a security system of this invention using ubiquitous computing,

FIG. 4 is a diagram for a health management system of this invention using ubiquitous computing,

FIG. 5 is a diagram for a multimedia processing system of this invention using ubiquitous computing,

FIG. 6 is a diagram for a multimedia platform of this invention,

FIG. 7 shows construction of a web-cam of this invention,

<Description of reference numerals for main parts in the drawings>

| | |
|---|---|
| 110: Home gateway | 120: Security system |
| 130: Cooling and Heating system | 140: Blind system |
| 150: Application Equipment | 160: Remote controller |
| 170: Home PC | 180: Modem |
| 210: Internet Center | 220: Wire/wireless Network |
| 230: External PC | 240: Portable wireless terminal |

### BEST EMBODIMENTS FOR THE INVENTION

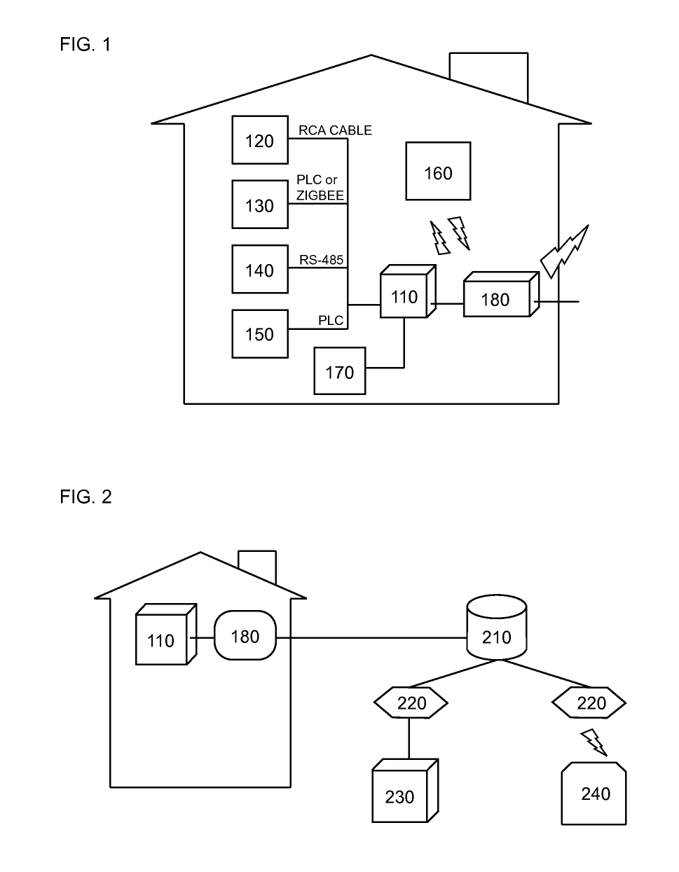

As shown in FIG. 1, a home network system with ubiquitous computing comprises a home network equipment that includes a home gateway (110), a security system (120), a cooling and heating system (130), a blind system (140) and an application equipment (150).

The home gateway (110) contains an OS based on Solaris or Linux, and is loaded with UPnP middleware. The interface for the home gateway (110) includes WAN, multiple LAN ports, RS-485, RS-232, video input/output terminals, Zigbee module, antenna, USB, speaker and external memory slot.

The security system (120) is connected to the home gateway (110) with RCA cable. The security system (120) has a doorbell for notifying visit by an outsider, and a video phone using web-cam or CCTV for checking the identity of the outsider from inside of a room.

The security system (120) may further include a door lock which can communicate with the home gateway (110) by Zigbee, and a motion detection sensor that can detect movement of a person who intruded the room without authorization.

The cooling and heating system (130), which is connected to the home gateway (110) with PLC or Zigbee communication method, includes a temperature sensor that can measure the indoor temperature, and a cooling and heating utility for maintaining indoor temperature at temperature set by a user.

The blind system (140), which is connected to the home gateway (110) with RS-485, 232 communication method, includes an illuminance sensor for measuring intensity of light from outside, and an electronic curtain that prevents the interior from being exposed to outside.

The application equipment (150), which is connected to the home gateway (110) with PLC communication method, includes kitchen appliances such as refrigerator, microwave oven, and living room appliances such as heater, television, home theatre, washer, humidifier, lighting system, and fan, which are used at home, and medical measuring equipments

The user can control the home network device by using a wire/wireless controller that is connected to home gateway (110). The wire/wireless controller includes a remote controller (160) that can communicate to the home gateway (110) with Zigbee, or a home PC (170) which is connected to the home gateway (110) with Ethernet.

Another wireless unit that can communicate with the home gateway (110) with Zigbee includes an environment sensor, which can sense temperature, humidity, heat and gas, etc., in addition to the remote controller (160).

As shown on FIG. 2, the home gateway (110) is connected to a server of the Internet Center (210) via a modem (180) which is connected with cable or wireless. The Internet Center (210) with its server saves information transmitted by the home gateway (110), and simultaneously transmits images together with letters to a portable wireless terminal (240) and the user's external PC (230) that are located outside via the wire/wireless network (220).

### Aspects for Using the Invention

### Embodiment 1

### Security System Using Ubiquitous Computing

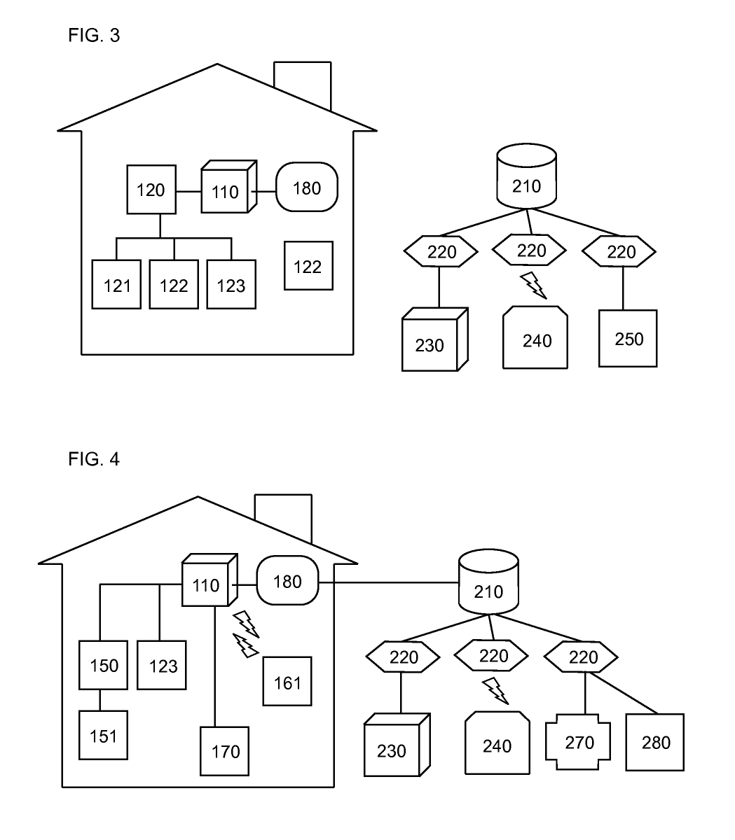

FIG. 3 shows the formation of the security system using ubiquitous computing according to the present invention.

When the user leaves the house, an outsider can deactivate the lock system (121) placed at the door and break into the house. At this time, when the lock system (121) does not get deactivated the way it should, electric signal is sent to home gateway (110) and the home gateway (110) activates the security system (120). The motion detection sensors (122), which are included in the security system (120), are installed in the living room and all other rooms to sense all the movement of the outsider, and the web-cam or CCTV (123) films the outsider's look and movement path.

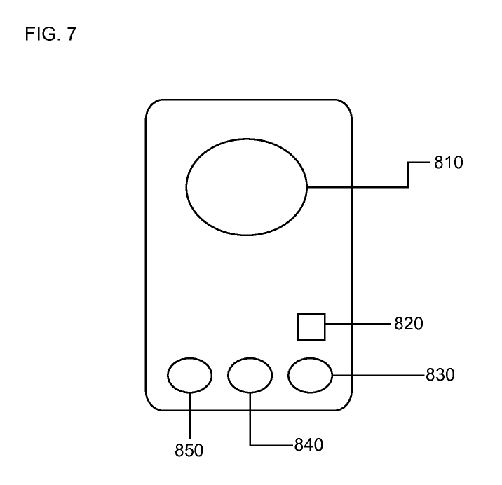

As shown on FIG. 7 the web-cam of this invention includes a CMOS sensor (810), a microphone (820), an LED lighting (830), a speaker (840) and a passive infrared ray sensor (850).

The CMOS sensor (810) films video or picture and the passive infrared ray sensor (850) senses the movement of the object.

If the web-cam is applied to the security system (120), the passive infrared ray sensor (850) senses the movement of trespasser and the LED lighting (830) and speaker (840) turns on lighting and generate warning sound to the trespasser.

At the instant the security system (120) starts working, the home gateway (110) sends video signal of the trespasser and operation signal of the security system (120) to the internet center (210) via the modem (180). The internet center (210) saves the received video, transfers message that the security system (120) is activated to a guard system (250) as well as to the external PC (230) located in the user's office and the portable wireless unit (240) via the wire/wireless network system (220), and simultaneously displays the video filmed by the web-cam or the CCTV (123).

Meanwhile, the guard system (250) uses the received information to check trespasser's appearance, and immediately take actions to dispatch professional personnel to the user's residence to resolve the situation.

### Embodiment 2

### Health Management System Using Ubiquitous Computing

FIG. 4 is a structural diagram for a system using home network of this invention. The user can use wire/wireless medical device to check health status of himself, and may receive medical service and emergency rescue services according to it.

First, the user uses a medical measuring device (151) among the application equipment (150) to figure height, weight, blood sugar level, and vital signs, etc. And the user can input body information to the home PC (170) that is connected to the home gateway (110).

If a wireless medical measuring device (161) that can Zigbee communicate with the home gateway (110) is attached to the body of a patient who requires constant attention, the patient's status information including vital signs is sent to the home gateway (110) in real time.

According to the embodiment of this invention, the wireless medical measuring device (161) is in form of a watch with a bio sensor attached, which is wearable on the wrist and has blue tooth connection to a guardian's portable wireless terminal (240). The web-cam or CCTV (123) monitors the patient's movement.

In this way, information for the user's status and movement, which was obtained through the home PC (170), wire/wireless medical measuring device (151, 161) and web-cam/CCTV (123), is sent to the home gateway (110). The information received by the home gateway (110) is transmitted to a hospital that is near to user's residence, medical system (270) such as health center or home doctor, emergency facility (280) and to a guardian's portable wireless terminal (240) through the modem (180).

The medical system (270) classifies the received status information of a user or a patient, and treatment record in the past when she visited into disease name, treatment record, prescription and later status, conform it to a database, and store it. And after continuous monitoring of received status information, visit is made or contact requesting coming is made if necessary, thereby enabling timely medical service at appropriate moment.

Meanwhile, the emergency rescue system (280) receives and monitors vital signs measured by the wireless medical measuring device (161) attached to the body of the patient who requires observation, and patient's movement filmed by webcam/CCTV (123) in real time. In emergency, a professional emergency rescuer can be sent to the patient's residence to perform emergency treatment or evacuate the patient to the hospital.

### Embodiment 3

### Home Automation Using Ubiquitous Computing

In FIG. 1, the user inputs set values such as indoor illuminance, temperature, humidity, and air clarity using home PC (170) which is connected to home gateway (110) in a room. Or the user can use the remote controller (160) which can communicate with the home gateway (110) by Zigbee, and input set values to control the desired application equipment (150) on a menu displayed on a display connected to the home gateway (110).

The environment sensor that is connected to the home gateway (110) measures environmental status such as indoor illuminance temperature, heat, humidity and air clarity in real time and sends the measurement to the home gateway (110).

The home gateway (110) compares the measurement from environment sensor and the set value that the user input, and sends operation signal so that the cooling and heating system (130), the blind system (140) and the application equipment (150) can operate.

Meanwhile, the illuminance sensor provided in the blind system (140) measures the indoor illuminance. The home gateway (110) compares the indoor illuminance measured by the illuminance sensor, and the set value that the user input, and performs turning on and off of the lighting, and opening and closing of the electronic curtain. For example, during summer afternoon if the indoor temperature rises due to heat inflow and direct light emitted from outside, the electronic curtains can be put on to decrease the temperature indoors.

And the cooling and heating system (130) also controls the indoor temperature by comparing the user set-up hourly temperatures and the measured temperature by the temperature sensor and operating the cooler and heater. Especially, when the user sets a return home time and desired indoor temperature before he goes out, the home gateway (110) operates the cooler and heater according to the return home time or turns on lighting thereby improving user's life convenience.

Humidity and air clarity can be also controlled per user's desired indoor environment with the above disclosed operation principles.

Such indoor environment control by the home gateway (110) can give effective cooling/heating especially during summer/winter under various environment conditions.

Meanwhile, the home gateway (110) sends such set value and measured value information to the Internet center (210) via the modem (180). Then the internet center sends information to user's external PC (230) and portable wireless terminal (240). Therefore, the user can check operation status of the indoor home network equipments in real time and from outside, based on information measured by the various sensors provided in home.

Also the home gateway (110) manages the set values that user input per day/night, weekly, monthly, seasonal data, and transmits environment status information, which is required to make pleasant residential environment, to user. The user can also operate scenarios pursuant to values set in advance.

Meanwhile, the user checks emergencies such as gas leak in a room, and fire, etc. or whether the home network equipment operates via message and display, when he is out. And the user can control the application equipment (150) via the external PC (230) and the portable wireless terminal (240) if necessary.

### Embodiment 4

### Multimedia System Using Ubiquitous Computing

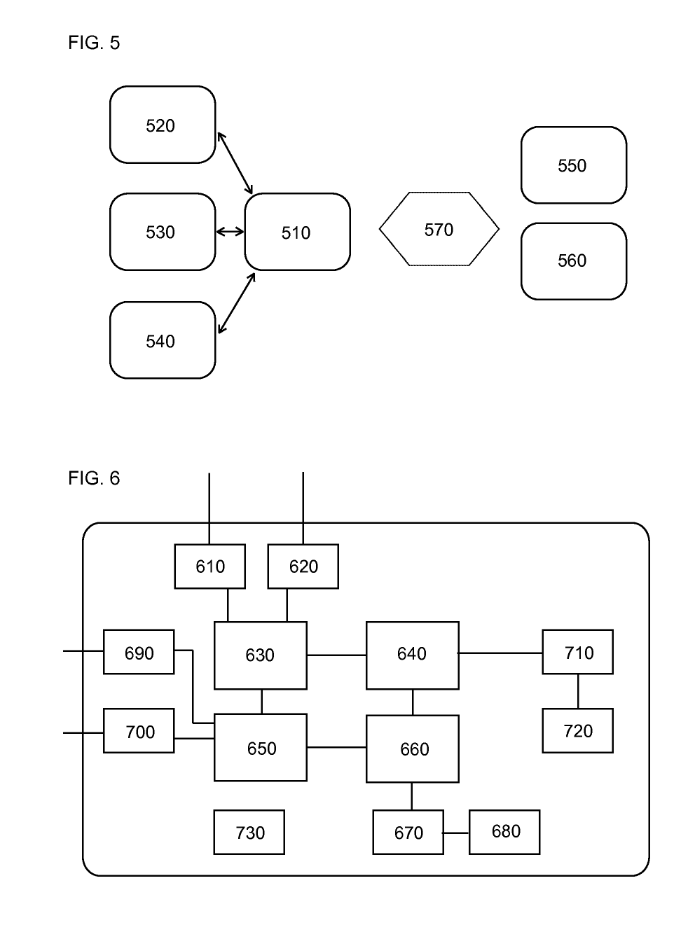

FIG. 5 shows the formation of the multimedia system of this invention using ubiquitous computing.

A ubiquitous multimedia platform (510) for handling videos can be embedded in the home gateway (FIG. 1, 110) or provided as a separate device. The multimedia platform (510) is connected to a filming device (520) such as CCTV or webcam and to television and PC/server monitor (530) using wire. The multimedia platform (510) can be additionally connected to a monitor (540) of a POS device in a store, and these devices can communicate with a portable wireless terminal (550) and a laptop (560) using the wireless network (250).

The ubiquitous multimedia platform (510) connects to the internet using external wire/wireless modem. Modems such as ADSL, VDSL and cable modem can be used.

The ubiquitous multimedia platform (510) provides wireless Access Point (AP) function that can connect multiple devices that are connected with wireless LAN inside a house.

Also, the ubiquitous multimedia platform (510) allows sharing of data between the PC, laptop, PDA and other display available devices.

For example, if the user powers the filming device (520) that is installed indoors, the video filmed by the filming device (520) is sent to the ubiquitous multimedia platform (510). And the ubiquitous multimedia platform (510) sends the filmed video and audio to television, PC/server monitor (530), portable wireless terminal (550) and laptop (560).

Therefore at outside, the user can see the video and image filmed by the filming device (520), television, PC/server monitor (530), store's POS monitor (540) on the laptop (560) and the portable wireless terminal (550). The user can select one among the multiple filming devices (520) installed indoor, TV and PC/server monitor (530), and the store's POS monitor (540) and watch the image filmed at the corresponding device.

And when the outside PC, which is installed outside, is used, the user can run a special software to see multiple videos from the multiple filming devices (520) all on one screen, divided into small fractions.

FIG. 6 is a block diagram showing construction of this invention'subiquitous multimedia platform.

The multimedia platform of this invention can be embedded in the home gateway, or can be formed as a separate device.

The ubiquitous multi-platform comprises includes input/output ports, 4 each, CPU, memory, converter and network interface.

The ubiquitous multimedia platform's input port comprises VGA, DVI and HDMI input port (610) and analog video input port (690) to which digital and analog images that would be filmed or displayed are input, USB port (710), external memory slot (720) and WAN (670).

Video and image data that were input to the VGA, DVI, and HDMI input port (610) is converted to NTSC at a converter (630), and after a CPU (650) finally converts NTSC into various compress video file and image format such as MPEG4 and JPEG, is output through VGA, DVI and HDMI output port (620). Analog video and image are also input through analog video input port (620) then converted to compressed format at CPU (650), and output through analog video output port (700).

The ubiquitous multimedia platform is provided with WAN (670) port, thus it can receive videos filed by webcam and portable wireless terminal, convert into compressed video file format at the CPU (650), and output via VGA, DVI and HDMI output port (620), video output port (700), or transmit to different devices connected to LAN port (680).

The web-cam (FIG. 7) can be applied to store and meeting room, etc, which will enable real-time video conference.

The memory slot (720) and USB port (710) provide in the ubiquitous multimedia platform enable checking video or image stored or filmed by various storage media and or electronic devices through other devices.

Also, the ubiquitous multimedia platform has a speaker or audio output port (730), and therefore can output voice that was input, or transmit is to an external device via the output port.

Meanwhile, the video and image data that were converted into compressed format by processing at the CPU (650) is sent to the internet center using WAN (670) again.

The internet center comprises a server that can store the video and image data and simultaneously can send data to user's external PC and portable wireless terminal that are located outside.

1. A multifunctional home network system using ubiquitous computing comprising:
a home network equipment that comprises one of more among a security system that comprises an imaging device that is connected to a home gateway with wire/wireless communication method, cooling and heating system, and application equipments;
a wire/wireless controller that can communicate wire/wireless with said home gateway to directly control said home network equipment via said home gateway, or to input control value for control under set value;
an internet center that comprises a server to receive and store operation signal for said home network equipment via wire/wireless network, and transmits letters and images to user's external PC and portable wireless terminal that can control said home network equipment; and
one or more receiving places among a security system, medical system and emergency rescue system that receive and monitor image and voice signals among said operation signals stored in said internet center.

2. The multifunctional home network system using ubiquitous computing in claim 1, further comprising a blind system that can communicate with said home gateway via RS-485.

3. The multifunctional home network system using ubiquitous computing in claim 2, wherein the blind system comprises an illumination sensor and an electronic curtain.

4. The multifunctional home network system using ubiquitous computing in claim 1, wherein said security system can communicate with said home gateway with an RCA cable.

5. The multifunctional home network system using ubiquitous computing in claim 4, wherein said security system comprises one or more among web-cam, CCTV, door bell, lock device, video phone and motion detection sensor.

6. The multifunctional home network system using ubiquitous computing in claim 5, wherein said web cam comprises a CMOS sensor, and LED lighting, a microphone, a speaker and a passive infrared ray detection sensor.

7. The multifunctional home network system using ubiquitous computing in claim 1, further comprising a multimedia platform that comprises an input port for input image signal and voice signal that are taken one or more among the webcam and the CCTV, a converter for converting the image signal that is input to said input port into analog image signal, a CPU for converting said image signal into a compressed image file format, an output port for outputting said compressed image file format, and a speaker for outputting said voice signal.

8. The multifunctional home network system using ubiquitous computing in claim 1, wherein said cooling and heating system can communicate with said home gateway using one or more among PLC and Zigbee.

9. The multifunctional home network system using ubiquitous computing in claim 8, wherein said cooling and heating system comprises a temperature sensor, a heater and a cooler.

10. The multifunctional home network system using ubiquitous computing in claim 1, wherein said application equipments comprise a kitchen device, a living room device and a wired medical measurement device.

11. The multifunctional home network system using ubiquitous computing in claim 1, further comprising one or more among an environment sensor and a wireless medical measurement device that can communicate with said home network by Zigbee.

12. The multifunctional home network system using ubiquitous computing in claim 11, wherein said environment sensor can sense heat, temperature, humidity, illumination, air clarity, and gas.

13. The multifunctional home network system using ubiquitous computing in claim 1, wherein said wire/wireless controller comprises a remote controller that can communicate with said home gateway by Zigbee, and a home PC that is connected with said home gateway by wire.
